(19) United States
(12) Patent Application Publication
(10) Pub. No.: US 2025/0101835 A1
(43) Pub. Date: Mar. 27, 2025

(54) METHODS OF GENERATING METHANOL FROM CO2 AS HYDROGEN CARRIER TO POWER OILFIELD OPERATIONS

(71) Applicant: Halliburton Energy Services, Inc., Houston, TX (US)

(72) Inventors: Ronald Glen Dusterhoft, Houston, TX (US); Philip D. Nguyen, Houston, TX (US)

(73) Assignee: Halliburton Energy Services, Inc., Houston, TX (US)

(21) Appl. No.: 18/372,492

(22) Filed: Sep. 25, 2023

(51) Int. Cl. E21B 41/00; B01J 19/08; C01B 3/26; C25B 3/03; C25B 3/26; C25B 5/00; C25B 15/08; H01M 8/1011

(52) U.S. Cl. CPC E21B 41/0085; B01J 19/088; C01B 3/26; C25B 3/03; C25B 3/26; C25B 5/00; C25B 15/081; H01M 8/1011; B01J 2219/0869; B01J 2219/0871; B01J 2219/0898; C01B 2203/0861; C01B 2203/1235

(57) ABSTRACT

A method may include: providing a methanol fuel cell and methanol; reacting the methanol in the methanol fuel cell to generate at least electricity; powering wellbore equipment at least in part using the electricity generated in the methanol fuel cell; and performing a wellbore operation using the wellbore equipment.

### BACKGROUND

During the drilling and completion of oil and gas wells, various wellbore treatments are performed on the wells for a number of purposes. For example, hydrocarbon-producing wells are often stimulated by hydraulic fracturing operations, wherein a servicing fluid such as a fracturing fluid may be introduced into a portion of a subterranean formation penetrated by a wellbore at a hydraulic pressure sufficient to create or enhance fractures therein. Such a fracturing treatment may increase hydrocarbon production from the well.

At a well stimulation site, there are several pieces equipment on location that must be powered such as mixers, liquid handling equipment, sand handling equipment, blenders, a plurality of high-pressure hydraulic pumping units, a control center, for example. The equipment on location is used to deliver fluid/proppant mixtures to a wellhead at high-pressures to perform a well stimulation operation. The well stimulation equipment is typically powered by diesel engines, either directly driving pumping equipment, or by using a diesel-powered generator to generate electricity which is then used to power the well stimulation equipment.

There is increasing regulatory concern for well site emissions including carbon dioxide and light hydrocarbons such as methane and ethane. There is increasing interest in the oilfield in carbon capture and sequestration (CCS) to reduce the well site emissions. However, there are several challenges with CCS implementation at a well site including that CCS technology is energy intensive and requires additional equipment for CO2 capture, compression, transportation, and storage. While there have been some alternative non-carbon fuels suggested in industry, such as hydrogen, there are limitations of using non-carbon fuels to power well stimulation equipment. For example, hydrogen is highly flammable and forms explosive mixtures with air at low volumetric concentrations and requires specialized high-pressure tanks or cryogenic tanks to use.

### BRIEF DESCRIPTION OF THE DRAWINGS

These drawings illustrate certain aspects of some of the embodiments of the present disclosure and should not be used to limit or define the disclosure.

FIG. 1 is a schematic illustration of a system in accordance with some embodiments of the present disclosure.

FIG. 2 is a schematic illustration of a system for powering wellbore stimulation equipment.

### DETAILED DESCRIPTION

Disclosed herein are methods and systems for powering well stimulation equipment and, more particularly, disclosed are methods of powering well stimulation equipment by utilizing a methanol fuel cell to generate electricity which is then used to power the well stimulation equipment to perform a well stimulation operation. In further embodiments, the methanol is synthesized using carbon dioxide and methane as material inputs. In some embodiments, at least a portion of the carbon dioxide is captured from well stimulation equipment or other industrial sources. In further embodiments, at least a portion of the methane is captured methane such as methane captured during the production of oil and gas. Excess methane which cannot be readily pipelined or utilized is oftentimes sent to flare as a waste product. The methods and systems disclosed herein reduce carbon and methane emissions associated with wellbore construction, formation stimulation, and production of oil and gas.

The presently disclosed methods and systems have several advantages as compared to directly capturing carbon from a well site for carbon capture and storage (CCS). As will be discussed below, the methanol fuel cell produces a high purity carbon dioxide stream which can be utilized for further production of methanol, thereby reducing the carbon intensity of methanol production. Additionally, the methods disclosed herein can include green methanol, renewable methanol, or bio-methanol such as methanol produced from biological sources, including from fermentation, biomass gasification, or any other suitable biological source of methanol. Further, methanol as a fuel has several advantages over alternative proposed fuels such as hydrogen including that methanol is relatively safer to handle and has a higher energy density than hydrogen,

In embodiments, the methanol utilized in the methanol fuel cell to power the well stimulation equipment is produced from the hydrogenation of carbon dioxide, wherein the hydrogen required for hydrogenation is produced from decomposition of methane. The methane utilized to produce the hydrogen can be from any source, including from reclaimed methane captured from oil and gas production, transportation, and refining, and/or biogenic methane and renewable methane.

Methane gas (CH₄) can be released from a wellhead as well as from various production equipment such as oil/water separators and other surface production equipment. Membrane separators, and/or metal organic frameworks, can be used to separate and purify methane from other gas components at the wellsite before capture. The captured methane can be turned into hydrogen and solid carbon by a methane decomposition reactor including a methane pyrolysis reactor, a microwave pyrolysis reactor, or a microwave plasma pyrolysis reactor, for example. Carbon dioxide (CO₂) can be emitted as a component of exhaust gas at a wellsite by oilfield equipment or from industrial plants. This carbon dioxide can be captured and injected into a methanol (CH₃OH) generation reactor to react with the hydrogen generated from methane to produce methanol in the presence of a catalyst under pressure and temperature. Carbon dioxide capture can be accomplished by any suitable methods including sorptive methods using an amine absorption unit and/or direct air capture (DAC) carbon capture sequestration techniques, for example. The produced methanol can then be used as fuel source for methanol fuel cells to generate electricity to power oilfield equipment, other electronic devices, and/or charge batteries. Further, the heat generated by the methane decomposition reactor, the methanol generation reactor, and the methanol fuel cell (or methanol combustion engine) can be recovered by waste heat recovery units to pre-heat the methane decomposition reactor and/or the methanol generation reactor. As methanol generation reactors produce water and carbon dioxide as byproducts, the generated carbon dioxide can be recycled into the methanol generation reactors to make more methanol. Further, as methanol fuel cells produce water, heat, and traces of carbon dioxide as byproducts, the generated carbon dioxide can be recycled into the methanol generation reactors to make more methanol as well.

While the preceding description describes the use of methane gas released from a wellhead, present embodiments are not limited to the use of methane from a wellhead. Rather, any suitable source of methane may be used for methane decomposition. Examples of suitable methane sources include captured methane from the wellhead, captured methane from landfills, captured methane from cattle and dairy farms, or captured methane from steam methane reforming. In some embodiments, methane gas from a wellhead may be supplemented with additional fuel delivered to the location. In some embodiments, the methane gas may include waste gas that is typically flared. Further, methane can be replaced in the methane decomposition reactor by natural gas liquids mix and/or natural gas liquids waste stream including ethane, propane, butane, and hexane, as source of hydrogen.

In further embodiments, the methane is included in a hydrocarbon mixture with other hydrocarbons, water, and/or sulfur containing compounds, for example. In embodiment the feed to a decomposition reactor includes a Y-Grade hydrocarbon which may include hydrocarbons such as ethane, propane, butane, hexane. Y-grade is a natural gas liquid mixture that has been through field processing but has not been fractionated. Y-grade hydrocarbons are typically separated from natural gas before pipelining the natural gas product.

Methane decomposition can be performed by several processes in the methane decomposition reactor. In one or more embodiments, the system of the present disclosure uses methane pyrolysis or any suitable processes for methane decomposition. Methane pyrolysis includes heating methane above its decomposition temperature to break the C—H bonds into solid carbon and hydrogen gas. It is a one step process at relatively low cost as compared to steam methane reforming including carbon sequestration. In steam methane reforming, methane is fed into a reactor along with steam and contacts a catalyst to react to form hydrogen, carbon dioxide (CO₂), and carbon monoxide (CO). Steam methane reforming requires high operating temperatures in the range of 800° C. to 900° C., for example, to break the hydrogen bonds of the methane and relies on expensive materials as catalyst. If the CO₂ and CO by-products from steam methane reforming are captured and stored underground, then the produced hydrogen is coded as “blue hydrogen.” If the CO₂ and CO are not captured and stored underground, then the produced hydrogen is coded as “gray hydrogen.” Approximately 95% of all hydrogen in the United States of America and 50% globally is generated today by a steam methane reforming process. In an effort to decarbonize hydrogen production, carbon capture and storage (CCS) methods are being implemented within the industry, which have the potential to remove up to 90% of CO₂ produced from the steam methane reforming process.

However, there are several disadvantages to steam methane reforming. First, steam methane reforming produces approximately 7 kilograms (kg) of CO₂ per 1 kg of hydrogen produced and accounts for about 3% of global industrial sector CO₂ emissions. Second, steam methane reforming requires such high temperature reactor that several safety issues are present. Third, steam methane reforming can be very expensive ranging from $1 to over $3 per kilogram of hydrogen produced. Lastly, despite carbon capture and storage efforts to capture and store the carbon dioxide by-product, the implementation of this technology remains problematic, costly, and increases the price of the produced hydrogen significantly.

Methane pyrolysis operates at even higher temperatures. The dissociation of methane into methylene and a hydrogen molecule is observed in experiments at temperatures above 1400° C., while the decomposition of methane into a methyl radical and a hydrogen atom is observed in experiments at temperatures below 1400° C. In contrast with methane reforming, there is no need to capture and store carbon dioxide and carbon monoxide in methane pyrolysis as methane is converted into green hydrogen and solid carbon. Green hydrogen can be produced in large quantities for industries such as ammonia plants and refineries, but also to power hydrogen fuel cells. The solid carbon produced from methane pyrolysis can be used as a fuel source in direct carbon fuel cells (DCFC) for wellsite equipment. It can also be used in the manufacture of carbon ion batteries for wellbore equipment. Carbon ion batteries are more reliable and have fewer safety concerns compared to other common batteries such as lithium batteries. Solid carbon can also be used for soil amendment and environmental remediation. Further, the sale of solid carbon improves the economics of the methane pyrolysis process.

The decomposition of methane can include a free-radical scheme with the initiating reaction step corresponding to the dissociation of methane into a methyl radical and a hydrogen atom and formation of ethane and hydrogen molecules. In the second step, the rate of ethane formation falls gradually toward a plateau, and ethylene is obtained as a secondary product via the radical chain dehydrogenation of ethane. In addition, under certain conditions ethane can be dissociated into two methyl radicals. In the third step, acetylene and propylene are formed from ethylene via radical chain dehydrogenation and radical chain methylation reactions, respectively. At the same time, a sharp increase in the formation rate of ethane is observed. Finally, the formation of benzene occurs from acetylene and ethylene, and even if both hydrocarbons can form carbon directly, benzene and probably higher condensed aromatics are the main species for carbon growth. Regardless of the reaction temperature, the rate-limiting step is the decomposition of methane into a methyl radical and a hydrogen atom (at T<1400° C.) or the decomposition of methane into methylene and a hydrogen molecule (at T>1400° C.).

A lower temperature requirement and therefore a lower energy requirement can be achieved using a catalyst in the decomposition of methane. In this case, methane reacts with a catalyst to form hydrogen gas and solid carbon. The catalyst can help break the carbon-hydrogen bonds of the methane to produce hydrogen gas and solid carbon as shown in Reaction 1 below.

CH_{4(aq)}→C₍ₛ₎+2H_{2(g)} Reaction 1

The catalyst can be a metal, a metal alloy, a metal salt, or liquid metal. As used herein, the term “metal alloy” means a mixture of two or more elements, wherein at least one of the elements is a metal. The other element(s) can be a non-metal or a different metal. An example of a metal and non-metal alloy is steel, comprising the metal element iron and the non-metal element carbon. An example of a metal and metal alloy comprises bronze, comprising the metallic elements copper and tin. As used herein, the term “metal” means any substance that comprises a metal as a primary component (e.g., >50%) and includes pure metals and metal alloys. The catalyst can include pure metals or metal alloys, such as copper, nickel, cobalt, iron, manganese, chromium, vanadium, palladium, platinum, gold, silver, ruthenium, rhodium, iridium, or combinations thereof. A catalyst metal alloy can also include any of the aforementioned metals alloyed with a non-metal. The catalyst can also be a salt of any of the aforementioned metals. The metal salt may include metal chloride, metal fluoride, metal bromide, metal iodide, metal nitrate, metal triflate, or combinations thereof. By way of example, the metal of the metal salt may include a silver salt, such as silver chloride, silver fluoride, silver bromide, silver iodide, silver triflate, or combinations thereof. The metal of the catalyst can include a post-transition metal. The post-transition metal may include aluminum, gallium, indium, thallium, tin, bismuth, or combinations thereof. The post-transition metal may be alloyed with an alkali metal, alkaline earth metal, actinide metal, lanthanide metal, transition metal, or combinations thereof.

While improvements have been made to reduce the operating temperature of methane decomposition, current methane decomposition still requires operating temperatures above 500° C. even with the availability of new catalysts. In embodiments, the microwave plasma pyrolysis process uses electricity to generate microwaves that move methane into a plasma state, stripping off hydrogen atoms and initiating a chain reaction that creates solid carbon or petrochemical compounds including acetylene (C₂H₂), ethylene (C₂H₄), nanotube, carbon black, graphite and graphene. In the microwave plasma pyrolysis process, a magnetron fires microwaves (at 2.4 GHz for example) at methane, causing the few naturally occurring free electrons within the gas to vibrate rapidly, causing them to collide with other electrons that are then freed by that collision, causing a chain reaction that eventually frees a lot more of the electrons. The key component of the microwave methane pyrolysis process is the microwave reactor. The reactor includes a reaction chamber or cavity designed to withstand microwave radiation and high temperatures. The reactor can be made of materials that are transparent to microwaves including quartz or borosilicate glass. It can also be equipped with a waveguide system to deliver microwave energy into the reaction chamber. A microwave applicator is responsible for coupling the generated microwave energy into the reaction chamber. It can be in form of waveguide or a resonant cavity, depending upon the design of the system. This applicator ensures efficient energy transfer from the microwave source to the reactants. Microwaves selectively heat the methane molecules, including rapid and localized heating. The high-frequency oscillations of the microwaves preferentially heat polar molecules over non-polar molecules, including methane, to facilitate the pyrolysis reaction. The heat energy breaks down methane into carbon and hydrogen. Microwave plasma pyrolysis process offers several advantages, including faster reaction rates, selective heating, and more efficient energy transfer.

The hydrogen generated from the captured methane by the methane decomposition reactor is injected into the methanol generation reactor where it reacts with the captured carbon dioxide to produce methanol under pressure and temperature. Methanol can be synthesized by different processes. For example, carbon monoxide and hydrogen react over a catalyst to produce methanol:

CO+2H₂→CH₃OH Reaction 2

The catalyst includes any catalyst capable of favoring methanol synthesis including a mixture of copper and zinc oxides supported on alumina, for example. Carbon dioxide can also be reacted to form methanol as follows:

CO₂+3H₂→CH₃OH+H₂O Reaction 3

The carbon dioxide hydrogenation to methanol process is operated at pressures from about 50 bars to about 100 bars and temperatures from about 200° C. to about 300° C. The carbon dioxide hydrogenation to methanol process generates less heat than the syngas to methanol process. However, these reactions are still highly exothermic. The excess heat can be recovered to pre-heat methane inlet and/or pre-heat the methane decomposition reactor, and/or pre-heat the carbon dioxide inlet of the methanol generation reactor. Further, the present disclosure relates to improved efficiency of electricity generation from methanol fuel cells using methane and carbon dioxide as methanol fuel source, and more particularly, embodiments relate to recovering waste heat from the methane decomposition reactor, the methanol generation reactor, and the methanol fuel cells as heat source as well.

The methanol produced from the methanol generation reactor is then introduced into a methanol fuel cell. A fuel cell is an electrochemical device that converts the chemical energy from a gas (e.g., hydrogen) and an oxidizing agent (e.g., oxygen) into electricity through a pair of redox chemical reactions. Direct-methanol fuel cell is a subcategory of proton-exchange fuel cells in which methanol is used as fuel. A methanol fuel cell comprises an anode, a cathode, and a membrane. Methanol is supplied to the anode, where it undergoes oxidation in the presence of a catalyst, including platinum and ruthenium for example, releasing protons and electrons:

Anode: CH₃OH+H₂O→6H⁺+6e⁻+CO₂ Reaction 4

Cathode: 3/2O₂+6H⁺+6e⁻→3H₂O Reaction 5

Overall reaction: CH₃OH+3/2O₂43 2H₂O+CO₂ Reaction 6

The protons are transported through the membrane to the cathode, while the electrons flow through an external circuit, generating electrical current to power oilfield equipment, other electronic devices, and/or charge batteries. The membrane includes polymeric material which selectively allows protons to permeate through while preventing the direct flow of electrons. This feature enables the separation of the fuel oxidation and oxygen reduction reactions, preventing the fuel from directly reacting with the oxidant and allowing control on power generation. The anode includes a porous material, such as carbon paper or cloth, coated with the catalyst, for example. Oxygen is supplied to the cathode, where it undergoes a reduction. The cathode includes a porous material coated with a catalyst, such as platinum for example, which promotes the reduction of oxygen. At the cathode, oxygen from the air combines with protons and electrons to produce water as a byproduct.

Methanol fuel cells may be stationary or mobile. The electricity generated by the methanol fuel cells may be used for any suitable purpose. In some embodiments, the methanol fuel cells may be used to power well equipment, such as fracturing equipment at a well stimulation site. The methanol fuel cells may be coupled to the well equipment via a DC/AC converter and, in some embodiments, via a variable frequency drive (VFD). The methanol fuel cells may be arranged in a methanol fuel cell stack that is used to generate electricity to power various electrical devices (e.g., electric motors) of the well equipment. For example, the methanol fuel cells may be coupled to electric motors on pumping units and used to drive hydraulic pumps on the pumping units, thereby pumping fracturing fluid to a wellhead at a desired pressure. The hydraulic pumping units may include one or more reciprocating pumps, centrifugal pumps, vane pumps, or other types of pumps. Methanol fuel cells may be used to power other equipment on location as well, including a blender unit, a gel/ADP mixer unit, sand handling equipment, liquid handling equipment, a control center (e.g., tech center), and others. The well equipment may be driven partially or entirely by electrical power generated by the methanol fuel cells, as opposed to diesel engines that are conventionally used on location.

As methanol fuel cells produce water, heat, and traces of carbon dioxide as byproducts, the generated carbon dioxide can be recycled into the methanol generation reactors to make more methanol, lowering the carbon footprint in the process. Further, the present disclosure relates to improved efficiency of electricity generation from methanol fuel cells using methane and carbon dioxide as methanol fuel source, and more particularly, embodiments relate to recovering waste heat from the methanol fuel cells as a heat source for the methane inlet, and/or methane decomposition reactor, and/or carbon dioxide inlet for the methanol generation reactor.

In addition, the heat produced by the hydraulic pumping units and other machinery on location to pump hydraulic fracturing fluids downhole can also be recovered to pre-heat the methane inlet and/or methane decomposition reactor, and/or carbon dioxide inlet for the methanol generation reactor. Therefore, the system in accordance with some embodiments of the present disclosure comprises a reaction system for decomposition of methane to hydrogen, a methanol generation reactor to produce methanol from carbon dioxide and hydrogen, and a methanol fuel cell for generation of electricity from at least a portion of the methanol, and at least one waste heat recovery unit for recovering waste heat from the methane decomposition unit, the methanol generation reactor, and the methanol fuel cell for use as a heat source in the methane decomposition and for the methanol generation reactor.

The waste heat generated by the methane decomposition reactor, the methanol generation reactor, and the methanol fuel cells and/or the well equipment may be captured in a waste heat recovery unit in accordance with one or more embodiments. The waste heat recovery unity may include, for example, one or more heat exchangers. For example, a heat exchanger(s) may recover waste heat from the fuel cell for use in the methane decomposition. By way of example, an additional heat exchanger(s) may recover waste heat from the well equipment for use in the methane decomposition. The heat recovered in the waste heat recovery unity may be transferred, for example, to any suitable heat transfer medium such as a heat transfer fluid (liquid or gas), a solid conductive material, or electromagnetic waves. For example, the thermal energy can be transported using any suitable heat transfer liquid such as hydrocarbon oil, or synthetic oil, molten salts, and molten metals, or silicon-based fluids, as well as gases such as water vapor, nitrogen, argon, or helium. Additional heat transfer liquids such as liquid water, glycol-based liquid or any other heavy-duty antifreeze liquid can also be used in additional examples.

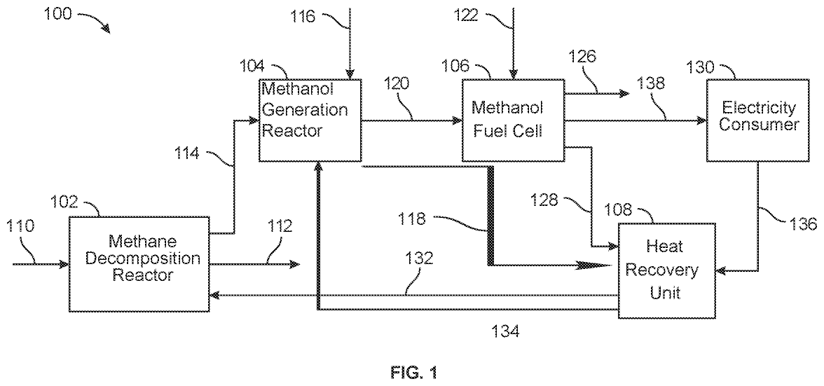

FIG. 1 is a schematic illustration of system 100 in accordance with some embodiments of the present disclosure. As illustrated, system 100 includes a methane decomposition reactor 102, a methanol generation reactor 104, a methanol fuel cell 106, and a heat recovery unit 108. In the illustrated embodiment, methane from methane supply 110 provides methane to the methane decomposition reactor 102 for decomposition of methane. Methane supply 110 may be from any suitable source including methane captured gas from a well or additional fuel supplied to the location. In methane decomposition reactor 102, the methane may be decomposed into solid carbon and hydrogen gas. Methane decomposition reactor 102 may include preheaters, reactors, and other suitable equipment as described herein for decomposition of the methane. The preheater may include a heat exchanger heated by a working fluid heated by the heat recovery unit 108. As illustrated, the solid carbon may be withdrawn from the methane decomposition reactor 102 as carbon product 112 while the hydrogen gas may be supplied via hydrogen line 114 to methanol generation reactor 104 in fluid communication with the methane decomposition reactor 102.

Methanol generation reactor 104 may include any reactor capable of producing methanol from hydrogen 114 and carbon dioxide 116. Carbon dioxide 116 may include any carbon dioxide produced on well site and/or any industrial site. Methanol generation reactor 104 can be operated at pressures from about 50 bars to about 100 bars and temperatures from about 200° C. to about 300° C. and is capable of coping with the exothermic reaction. The excess heat can be recovered by the heat recovery unit 108 through fluid conduit 118. The produced methanol 120 is provided to methanol fuel cell 106. Methanol fuel cell 106 may produce electricity 138 when methane supply 110 is combined with oxygen 122. Oxygen 122 may include any suitable source of oxygen, including pure oxygen, oxygen-enriched air (>21% mole % oxygen), and air, among others. In addition to electricity 138, methanol fuel cell 106 may also produce water 126 and waste heat 128. Electricity 138 may be provided to an electricity consumer 130, which may be any suitable consumer of electricity, including, well equipment (e.g., pumping equipment) or other suitable electric devices. Electricity consumer 130 may be any type of electrically powered fracturing pumping equipment capable of injecting hydraulic fracturing fluids at high pressures such as any reciprocating positive displacement pump with a fluid end and a power end. The fracturing pumping equipment may be any electrically powered triplex pumps or any electrically powered quintuplex pumps for instance.

The waste heat 128 from the methanol fuel cell 106 may be provided to a heat recovery unit 108 so that it can be recovered to reduce the heat requirements for the methane decomposition reactor 102 and the methanol generation reactor 104. The heat recovery unit 108 may use any suitable technique for recovering the waste heat through fluid conduit 118 and waste heat 128. For example, the heat recovery unit 108 may include one or more heat exchangers, which can recover the heat into any suitable heat transfer medium as previously described. The recovered heat from the heat recovery unit 108 may be provided to the methane decomposition reactor 102 by way of a heat transfer fluid line 132 and/or to the methanol generation reactor 104 through heat transfer fluid line 134. Additional waste heat 136 may also be recovered from the electricity consumer 130. The additional waste heat 136 may utilize the same heat transfer equipment for recovery of the waste heat 128 from the methanol fuel cell 106 or the additional waste heat 136 may utilize additional equipment (e.g., additional heat exchangers) for heat recovery. The heat recovered from the additional waste heat 136 may also be used to reduce the heat requirement of the methane decomposition reactor 102.

For the sake of clarity in FIG. 1, the recovery of carbon dioxide from the methanol generation reactor and from the methanol fuel cell and its injection back to the methanol generation reactor is not shown.

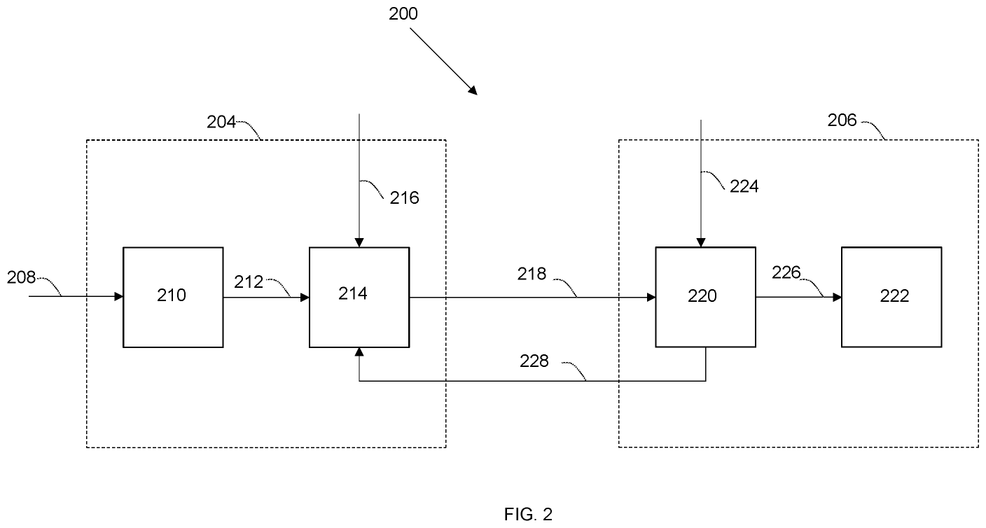

FIG. 2. is a schematic illustration of a process 200 for powering wellbore stimulation equipment. Process 200 includes two principal components, methanol generation step 204 and methanol consumption step 206. In methanol generation step 204, methane gas 208 is introduced into methane decomposition reactor 210. Methane decomposition reactor 210 may include preheaters, reactors, and other suitable equipment as described herein for decomposition of the methane. The decomposition of methane is exothermic. In embodiments, a preheater may include a heat exchanger where the output of the methane decomposition reactor, such as a microwave methane pyrolysis reactor, is crossed with the input methane to pre-heat the methane. In further embodiments, heat generated in the methane decomposition reactor is captured, for example using a working fluid, which can then provide the heat required in the methanol generation reactor 214. Methane gas 208 may be from any source as described above and may include captured methane such as methane captured from oil and gas production. Methane decomposition reactor 210 includes any suitable methane decomposition reactor, including microwave plasma pyrolysis decomposition reactors. Methane decomposition reactor is operated under conditions such that methane gas 208 is decomposed to form at least hydrogen 212. From methane decomposition reactor 210, hydrogen 212 is introduced into methanol generation reactor 214 along with carbon dioxide 216. Carbon dioxide 216 can be from any suitable source, including carbon dioxide captured from wellbore construction and stimulation operations. Methanol generation reactor 214 is operated at conditions sufficient to hydrogenate at least a portion of carbon dioxide 216 to form methanol 218. Methanol 218 is introduced into methanol consumption step 206.

While shown in FIG. 2 as only having one methanol feed from methanol generation step 204, there may be disparate methanol generation steps such as fermentation, biomass gasification, or any other suitable methanol generation steps supply methanol to methanol consumption step 206.

In methanol consumption step 206, methanol 218 from methanol generation step 204, or any other methanol source such as renewable methanol, bio-methanol methanol from fermentation, and/or methanol from biomass gasification, is introduced into methanol fuel cell 220 along with oxygen 224. Methanol fuel cell 220 is operated under conditions such that methanol and oxygen are combined to produce electricity 226. Electricity 226 may be routed to wellbore equipment 222 for powering the wellbore equipment. In some embodiments, the methanol fuel cell 220 includes a plurality of methanol fuel cells disposed at a well site for power generation. The carbon dioxide produced from the methanol fuel cell 220 can be captured and routed back to methanol generation step 204 as carbon dioxide 228. In embodiments, wellbore equipment 222 includes but is not limited to equipment associated with drilling a borehole such as drilling rigs, and mud pits, for example, equipment useful in the construction of the wellbore such as cementing rigs, wellbore cementing pumps, and wellbore cementing mixers, for example, as well as wellbore stimulation equipment including, but not limited to fracturing mixers, liquid handling equipment, sand handling equipment, blenders, hydraulic fracturing pumps, and control centers, for example. In embodiments where the methanol fuel cells are utilized to power oilfield equipment, the methanol fuel cells may be positioned relatively close to the wellbore equipment, for example, within a radius of about 10 kilometers or closer from the wellbore equipment. Alternatively, in a range of 100 meters to 10 kilometers, or alternatively 10 kilometers or less, 5kilometers or less, 1 kilometer or less, or 100 meters or less.

In embodiments, electricity can power wellbore equipment comprising a wellbore cementing mixer, a wellbore cementing pump, or a combination thereof, which perform a wellbore operation comprising placing a cement slurry in an annular space between a wellbore casing and a borehole. In embodiments, electricity can power wellbore equipment comprising a drilling rig and a wellbore operation comprises extending a borehole through a subterranean formation using the drilling rig. In embodiments, electricity can power wellbore equipment comprising a hydraulic fracturing pump, a downhole blender, sand handling equipment, or a combination thereof, and a wellbore operation comprises introducing a fracturing fluid into a subterranean formation using the wellbore equipment.

Accordingly, the present disclosure provides methods and systems for powering well stimulation equipment and, more particularly, disclosed are methods of powering well stimulation equipment by utilizing a methanol fuel cell to generate electricity which is then used to power the well stimulation equipment to perform a well stimulation operation may include any of the various features disclosed herein, including one or more of the following statements.

Statement 1. A method comprising: providing a methanol fuel cell and methanol; reacting the methanol in the methanol fuel cell to generate at least electricity; powering wellbore equipment at least in part using the electricity generated in the methanol fuel cell; and performing a wellbore operation using the wellbore equipment.

Statement 2. The method of statement 1 wherein the wellbore equipment comprises a wellbore cementing mixer, a wellbore cementing pump, or a combination thereof, and the wellbore operation comprises placing a cement slurry in an annular space between a wellbore casing and a borehole.

Statement 3. The method of any of statements 1-2 wherein the wellbore equipment comprises a drilling rig and the wellbore operation comprises extending a borehole through a subterranean formation using the drilling rig.

Statement 4. The method of any of statements 1-3 wherein the wellbore equipment comprises a hydraulic fracturing pump, a downhole blender, sand handling equipment, or a combination thereof, and the wellbore operation comprises introducing a fracturing fluid into a subterranean formation.

Statement 5. The method of any of statements 1-4 further comprising: decomposing methane in a methane decomposition reactor to produce at least hydrogen; reacting at least a portion of the hydrogen and a carbon dioxide stream in a methanol generation reactor to produce at least methanol; and reacting at least a portion the methanol produced from the methanol generation reactor in the methanol fuel cell.

Statement 6. The method of statement 5 wherein the carbon dioxide stream comprises carbon dioxide captured from oilfield equipment exhaust gas.

Statement 7. The method of any of statements 1-6 wherein the methanol fuel cell further generates a carbon dioxide stream and wherein the method of claim 1 further comprises: decomposing methane in a methane decomposition reactor to produce at least hydrogen; reacting at least a portion of the hydrogen and at least a portion of the carbon dioxide stream in a methanol generation reactor to produce at least methanol; and reacting at least a portion the methanol produced from the methanol generation reactor in the methanol fuel cell.

Statement 8. The method of any of statements 1-7 wherein the methanol fuel cell is located within a radius of about 10 kilometers or less from the wellbore equipment.

Statement 9. A method comprising: decomposing a hydrocarbon feed comprising methane in a microwave plasma pyrolysis reactor to produce at least hydrogen and heat; and reacting at least a portion of the hydrogen with carbon dioxide in a methanol generation reactor to produce methanol, wherein at least a portion of the carbon dioxide is captured from exhaust gasses from oilfield equipment, and wherein at least a portion of the heat from the microwave plasma pyrolysis reactor is introduced into the methanol generation reactor.

Statement 10. The method of statement 9 further comprising utilizing at least a portion of the heat from the microwave plasma pyrolysis reactor to preheat the hydrocarbon feed.

Statement 11. The method of any of statements 9-10 wherein the hydrocarbon feed further comprises a Y-grade hydrocarbon.

Statement 12. The method of any of statements 9-11 further comprising reacting at least a portion of the methanol with oxygen in a methanol fuel cell to generate at least electricity and a recycled carbon dioxide stream.

Statement 13. The method of any of statements 9-12 wherein the recycled carbon dioxide stream is further introduced into the methanol generation reactor and reacted with the hydrogen to produce methanol.

Statement 14. The method of any of statements 9-13 further comprising: powering wellbore equipment at least in part using the electricity generated in the methanol fuel cell; and performing a wellbore operation using the wellbore equipment.

Statement 15. The method of statement 14 wherein the wellbore equipment comprises a wellbore cementing mixer, a wellbore cementing pump, or a combination thereof, and the wellbore operation comprises placing a cement slurry in an annular space between a wellbore casing and a borehole.

Statement 16. The method of any of statements 14-15 wherein the wellbore equipment comprises a drilling rig and the wellbore operation comprises extending a borehole through a subterranean formation using the drilling rig.

Statement 17. The method of any of statements 14-16 wherein the wellbore equipment comprises a hydraulic fracturing pump, a downhole blender, sand handling equipment, or a combination thereof, and the wellbore operation comprises introducing a fracturing fluid into a subterranean formation.

Statement 18. A system comprising: a hydrocarbon source comprising methane in fluid communication with a microwave plasma pyrolysis reactor configured to decompose methane into a reactor effluent comprising hydrogen; and a methanol generation reactor, wherein an inlet of the methanol generation reactor is in fluid communication with the reactor effluent and a carbon dioxide source, wherein at least a portion of the carbon dioxide source is captured from exhaust gasses from oilfield equipment, wherein the methanol generation reactor comprises a catalyst capable of hydrogenating carbon dioxide and hydrogen to form methanol, and wherein the methanol generation reactor is configured to contact the carbon dioxide and hydrogen in the presence of the catalyst at conditions sufficient to hydrogenate at least a portion of the carbon dioxide.

Statement 19. The system of statement 18 further comprising a preheater configured to thermally contact the hydrocarbon source and the reactor effluent.

Statement 20. The system of any of statements 18-20 further comprising a methanol fuel cell wherein the methanol fuel cell is configured to react methanol and oxygen to form at least electricity and a carbon dioxide recycle stream, and wherein the carbon dioxide source comprises at least the carbon dioxide recycle stream.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular examples disclosed above are illustrative only, as the present disclosure may be modified and practiced in different but equivalent manners apparent to those skilled in the art having the benefit of the teachings herein. Although individual examples are discussed, the disclosure covers all combinations of all those examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method comprising:
providing a methanol fuel cell and methanol;
reacting the methanol in the methanol fuel cell to generate at least electricity;
powering wellbore equipment at least in part using the electricity generated in the methanol fuel cell; and
performing a wellbore operation using the wellbore equipment.

2. The method of claim 1 wherein the wellbore equipment comprises a wellbore cementing mixer, a wellbore cementing pump, or a combination thereof, and the wellbore operation comprises placing a cement slurry in an annular space between a wellbore casing and a borehole.

3. The method of claim 1 wherein the wellbore equipment comprises a drilling rig and the wellbore operation comprises extending a borehole through a subterranean formation using the drilling rig.

4. The method of claim 1 wherein the wellbore equipment comprises a hydraulic fracturing pump, a downhole blender, sand handling equipment, or a combination thereof, and the wellbore operation comprises introducing a fracturing fluid into a subterranean formation.

5. The method of claim 1 further comprising:
decomposing methane in a methane decomposition reactor to produce at least hydrogen;
reacting at least a portion of the hydrogen and a carbon dioxide stream in a methanol generation reactor to produce at least methanol; and
reacting at least a portion the methanol produced from the methanol generation reactor in the methanol fuel cell.

6. The method of claim 5 wherein the carbon dioxide stream comprises carbon dioxide captured from oilfield equipment exhaust gas.

7. The method of claim 1 wherein the methanol fuel cell further generates a carbon dioxide stream and wherein the method of claim 1 further comprises:
decomposing methane in a methane decomposition reactor to produce at least hydrogen;
reacting at least a portion of the hydrogen and at least a portion of the carbon dioxide stream in a methanol generation reactor to produce at least methanol; and
reacting at least a portion the methanol produced from the methanol generation reactor in the methanol fuel cell.

8. The method of claim 1 wherein the methanol fuel cell is located within a radius of about 10 kilometers or less from the wellbore equipment.

9. A method comprising:
decomposing a hydrocarbon feed comprising methane in a microwave plasma pyrolysis reactor to produce at least hydrogen and heat; and
reacting at least a portion of the hydrogen with carbon dioxide in a methanol generation reactor to produce methanol, wherein at least a portion of the carbon dioxide is captured from exhaust gasses from oilfield equipment, and wherein at least a portion of the heat from the microwave plasma pyrolysis reactor is introduced into the methanol generation reactor.

10. The method of claim 9 further comprising utilizing at least a portion of the heat from the microwave plasma pyrolysis reactor to preheat the hydrocarbon feed.

11. The method of claim 9 wherein the hydrocarbon feed further comprises a Y-grade hydrocarbon.

12. The method of claim 9 further comprising reacting at least a portion of the methanol with oxygen in a methanol fuel cell to generate at least electricity and a recycled carbon dioxide stream.

13. The method of claim 12 wherein the recycled carbon dioxide stream is further introduced into the methanol generation reactor and reacted with the hydrogen to produce methanol.

14. The method of claim 12 further comprising:
powering wellbore equipment at least in part using the electricity generated in the methanol fuel cell; and
performing a wellbore operation using the wellbore equipment.

15. The method of claim 14 wherein the wellbore equipment comprises a wellbore cementing mixer, a wellbore cementing pump, or a combination thereof, and the wellbore operation comprises placing a cement slurry in an annular space between a wellbore casing and a borehole.

16. The method of claim 14 wherein the wellbore equipment comprises a drilling rig and the wellbore operation comprises extending a borehole through a subterranean formation using the drilling rig.

17. The method of claim 14 wherein the wellbore equipment comprises a hydraulic fracturing pump, a downhole blender, sand handling equipment, or a combination thereof, and the wellbore operation comprises introducing a fracturing fluid into a subterranean formation.

18. A system comprising:
a hydrocarbon source comprising methane in fluid communication with a microwave plasma pyrolysis reactor configured to decompose methane into a reactor effluent comprising hydrogen; and
a methanol generation reactor, wherein an inlet of the methanol generation reactor is in fluid communication with the reactor effluent and a carbon dioxide source, wherein at least a portion of the carbon dioxide source is captured from exhaust gasses from oilfield equipment, wherein the methanol generation reactor comprises a catalyst capable of hydrogenating carbon dioxide and hydrogen to form methanol, and wherein the methanol generation reactor is configured to contact the carbon dioxide and hydrogen in the presence of the catalyst at conditions sufficient to hydrogenate at least a portion of the carbon dioxide.

19. The system of claim 18 further comprising a preheater configured to thermally contact the hydrocarbon source and the reactor effluent.

20. The system of claim 18 further comprising a methanol fuel cell wherein the methanol fuel cell is configured to react methanol and oxygen to form at least electricity and a carbon dioxide recycle stream, and wherein the carbon dioxide source comprises at least the carbon dioxide recycle stream.
